(19) United States
(12) Patent Application Publication
(10) Pub. No.: US 2026/0156165 A1
(43) Pub. Date: Jun. 4, 2026

(54) Methods And Apparatus For Session Management And Mobility Management Procedure Conflict Handling In Mobile Communications

(71) Applicant: MediaTek Inc., Hsinchu City (TW)

(72) Inventors: Chin-Te Chen, Hsinchu City (TW); Ren-Huang Liu, Hsinchu City (TW); Pan-Yen Chiang, Hsinchu City (TW)

(73) Assignee: MediaTek Inc., Hsinchu City (TW)

(21) Appl. No.: 19/398,126

(22) Filed: Nov. 24, 2025

Related U.S. Application Data
(60) Provisional application No. 63/726,628, filed on Dec. 1, 2024.

(51) Int. Cl. H04L 65/1069; H04L 69/28

(52) U.S. Cl. CPC H04L 65/1069; H04L 69/28

(57) ABSTRACT

Various solutions for session management (SM) and mobility management (MM) procedure conflict handling in mobile communications are described. The user equipment (UE) may receive a network-initiated SM message comprising a configuration of a wait timer from a network node. Also, the UE may start the wait timer in an event that an MM procedure is complete. Further, the UE may respond to the network-initiated SM message based on the wait timer. The wait timer indicates the necessary waiting period for the UE before responding to the SM message, enabling the UE to correctly identify whether it is responding to a deferred or retransmitted SM message. This effectively eliminates issues resulting from desynchronization between the UE and the network.

### CROSS REFERENCE TO RELATED PATENT APPLICATION(S)

The present disclosure is part of a non-provisional application claiming the priority benefit of U.S. patent application Ser. No. 63/726,628, filed 1 Dec. 2024, the content of which herein being incorporated by reference in its entirety.

### TECHNICAL FIELD

The present disclosure is generally related to mobile communications and, more particularly, to session management (SM) and mobility management (MM) procedure conflict handling in mobile communications.

### BACKGROUND

Unless otherwise indicated herein, approaches described in this section are not prior art to the claims listed below and are not admitted as prior art by inclusion in this section.

In mobile communication systems such as the fifth generation (5G) system, the session management function (SMF) utilizes a set of internal timers (e.g., T3590, T3591, T3592, T3593, or T3594) to ensure the reliability and timely execution of various session management (SM) procedures. These timers are crucial for network resilience. For instance, the timer T3591 is specifically employed by the SMF to track the duration of the packet data unit (PDU) session modification procedure. If this timer expires without the SMF receiving an appropriate response from the UE or another network function, the SMF is typically required to either retry the modification procedure or roll back to the previous session state.

A major challenge arises from the relationship between mobility management (MM) and SM procedures. Specifically, the access and mobility management function (AMF) may not always expose the location registration (LR) event to the SMF. Consequently, when the UE initiates an MM LR procedure, such as a mobility registration update (MRU), a procedure conflict may occur between the SM and MM procedures. Although the UE attempts to send 5GSM messages on a best effort basis once 5GSM activities resume, the timers running at the SMF side may not be stopped. The state discrepancy leads to a 5GSM and 5GMM race condition, which imposes unintentional UE delays and forces retransmissions on both the UE and network. Since this negatively impacts user experience and resource efficiency, a more efficient method is mandated for handling conflicts during SM and MM procedures.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to session management (SM) and mobility management (MM) procedure conflict handling in mobile communications.

In one aspect, a method may involve an apparatus receiving a network-initiated SM message including a wait timer from a network node. The method may also involve the apparatus starting the wait timer in an event that an MM procedure is complete. The method may further involve the apparatus responding to the network-initiated SM message based on the wait timer.

In another aspect, an apparatus may comprise a transceiver which, during operation, wirelessly communicates with a network node of a wireless network. The apparatus may also comprise a processor communicatively coupled to the transceiver. The processor, during operation, may perform operations comprising receiving, via the transceiver, a network-initiated SM message including a wait timer from a network node. The processor, during operation, may also perform operations comprising starting the wait timer in an event that an MM procedure is complete. The processor, during operation, may further perform operations comprising responding to the network-initiated SM message based on the wait timer.

In yet another aspect, a method may involve a network node determining a wait timer for responding to a network-initiated SM message. The method may also involve the network node including the wait timer in the network-initiated SM message. The method may further involve the network node transmitting the network-initiated SM message to a user equipment (UE).

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to session management (SM) and mobility management (MM) procedure conflict handling in mobile communications. According to the present disclosure, a number of possible solutions may be implemented separately or jointly. That is, although these possible solutions may be described below separately, two or more of these possible solutions may be implemented in one combination or another.

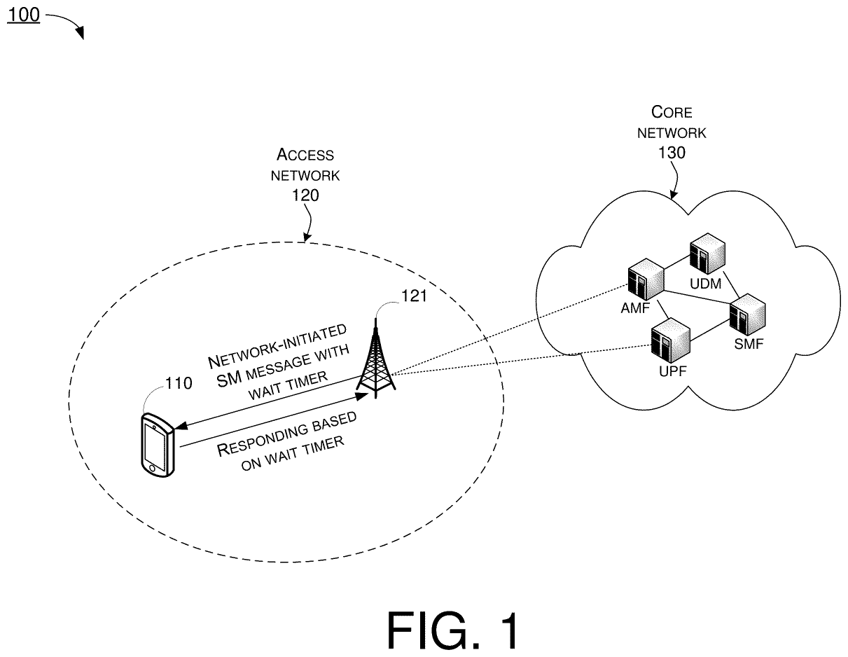

FIG. 1 illustrates an example scenario 100 of a communication environment in which various solutions and schemes in accordance with the present disclosure may be implemented. Scenario 100 involves a UE 110 in wireless communication with a wireless communication network (e.g., an LTE network, a 5G/NR network, an IoT network, or a 6G network) consisting of an access network 120 and a core network 130. The UE 110 may be a smart phone, a wearable device, an IoT device, and a tablet, etc. Alternatively, the UE 110 may be a notebook (NB) or personal computer (PC) inserted or installed with a data card which includes a modem and radio frequency (RF) transceiver(s) to provide the functionality of wireless communication. In one embodiment, the access network 120 is connected to the core network 130 by means of the NG interface, more specifically to a user plane function (UPF) by means of the NG user-plane part (NG-u), and to an access and mobility management function (AMF) by means of the NG control-plane part (NG-c). The access network 120 may include a base station (BS) 121, which may be connected to multiple UPFs/AMFs for the purpose of load sharing and redundancy. In addition, the core network 130 may include other entities, such as a session management function (SMF) and a unified data management (UDM), etc. To initiate a network-requested SM procedure, the SMF may transmit a network-initiated SM message to the UE 110, and start an SMF timer (e.g., T3590, T3591, T3592, T3593, or T3594) to determine whether an appropriate response from the UE 110 is received. The network-initiated SM message may be a PDU SESSION AUTHENTICATION COMMAND message, a PDU SESSION MODIFICATION COMMAND message, or a PDU SESSION RELEASE COMMAND message; however, the present disclosure is not limited thereto.

In scenario 100, when the UE 110 initiates an MM location registration (LR) procedure (e.g., a mobility registration update (MRU) procedure) by sending an MM location registration message, a procedure conflict may arise between the MM procedure and the SM procedure associated with the network-initiated SM message. To prevent synchronization issues between the SMF and the UE 110 that occur when the AMF performs a mobility change that is unknown to the SMF (which keeps its internal timer running), the present disclosure embeds a configuration of a wait timer within the NW-initiated SM message. The configuration may include the wait timer identifier/name (e.g., Timer X) and its start time information (e.g., Timer X: Run time value), to indicate when the wait timer should be started. Specifically, the wait timer indicates the extra waiting time for the SM procedure response after the MM procedure is complete. The UE 110 then utilizes this wait timer to govern its response to the SM message. More precisely, the UE may correctly identify whether it is responding to a deferred or retransmitted network-initiated SM message. In the present disclosure, the deferred network-initiated SM message refers to an SM message whose processing is delayed. In one embodiment, the value of the wait timer is specified in a general packet radio service (GPRS) timer information element (IE); however, the present disclosure is not restricted to this.

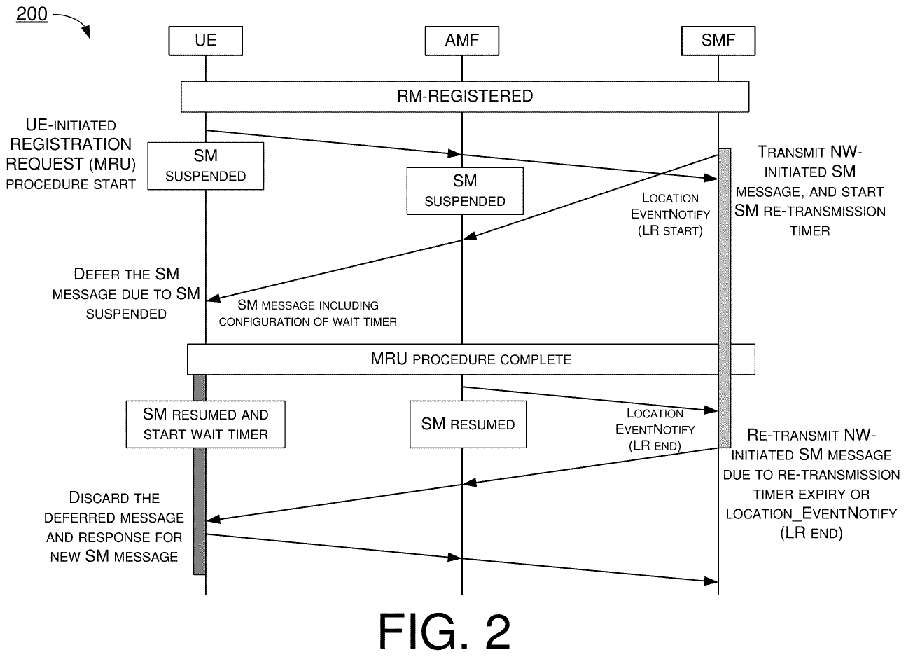

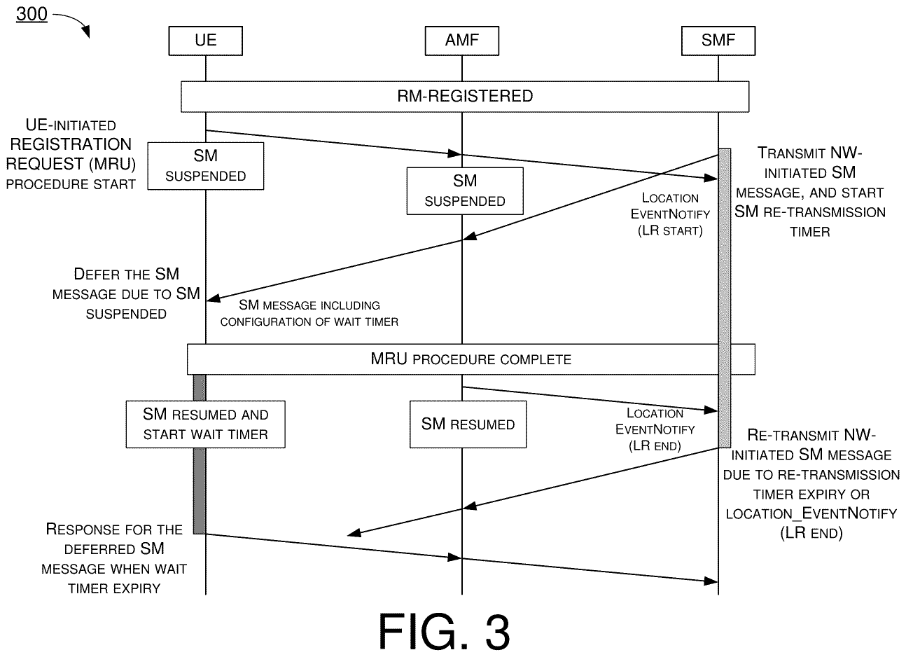

FIG. 2 and FIG. 3 illustrate two example scenarios 200 and 300 under schemes in accordance with implementations of the present disclosure, where a procedure conflict occurs between the SM and MM procedures. In scenarios 200 and 300, a UE in a registration management state (e.g., an RM-REGISTERED state) may initiate an MRU procedure. Concurrently, the SMF may transmit a NW-initiated SM message and start one or more SM re-transmission timers such as T3590, T3591, T3592, or T3593. Specifically, the NW-initiated SM message includes a configuration of a wait timer. The value of the wait timer may be specified in the GPRS timer IE. At the UE side, the processing of the NW-initiated SM message is deferred due to the SM procedure being suspended. After the MRU procedure is complete, the SM procedure resumes, and the UE starts the wait timer. The SMF may re-transmit the network-initiated SM message due to re-transmission timer expiry or a location event notification (e.g., LR end). The response of the UE is then based on whether a re-transmission network-initiated SM message is received before the wait timer expires.

In scenario 200, the re-transmission network-initiated SM message is received by the UE before the wait timer expires. The UE then discards the deferred network-initiated SM message, determines a response message for the re-transmission network-initiated SM message, and transmits the response message to the network.

In scenario 300, no re-transmission network-initiated SM message is received by the UE before the wait timer expires. Accordingly, the UE determines a response message for the deferred network-initiated SM message and transmits the response message to the network upon the wait timer expires. In one example, the UE may discard the re-transmission network-initiated SM message if it is received after the wait timer expires.

In another embodiment, if the network-initiated SM message does not comprise the configuration of the wait timer, the UE may defer the processing of the network-initiated SM message and transmit a response message for the deferred network-initiated SM message when the MM procedure is complete.

The wait timer configured in the network-initiated SM message allows the UE to determine both the duration it should wait before responding to the SM message and whether the intended response is for a deferred or a retransmitted SM message. This mechanism consequently prevents issues arising from desynchronization between the UE and the network side.

### Illustrative Implementations

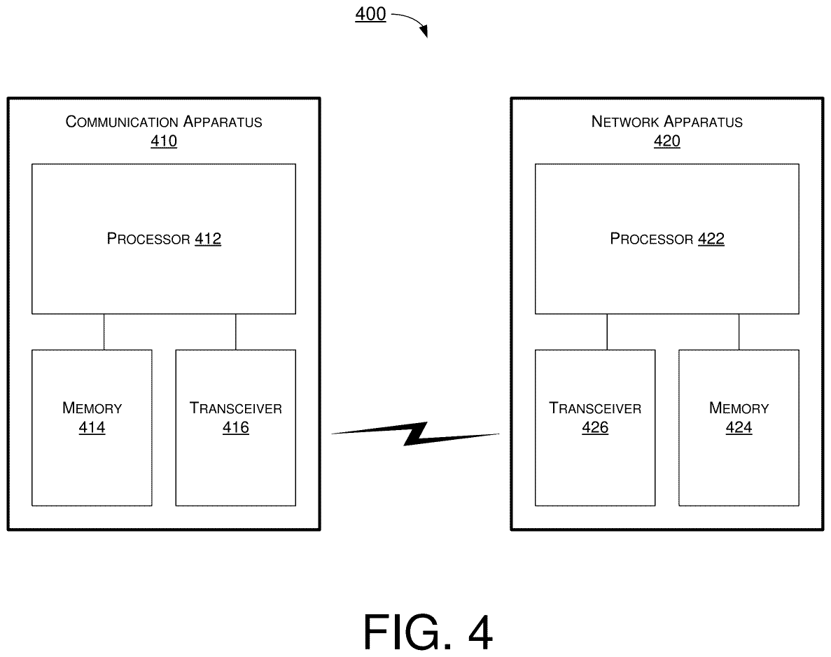

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to SM and MM procedure conflict handling in mobile communications, including scenarios/schemes described above as well as process 500 and process 600 described below.

Communication apparatus 410 may be a part of an electronic apparatus, which may be a UE such as a portable or mobile apparatus, a wearable apparatus, a wireless communication apparatus, or a computing apparatus. For instance, communication apparatus 410 may be implemented in a smartphone, a smartwatch, a personal digital assistant, a digital camera, or a computing equipment such as a tablet computer, a laptop computer, or a notebook computer. Communication apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed scheme of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of a network apparatus, which may be a network node such as a satellite, a base station, a small cell, a router a gateway, or other network element (e.g., SMF). For instance, network apparatus 420 may be implemented in an eNodeB in an LTE network, in a gNB in a 5G/NR, IoT, NB-IoT or IIoT network or in a satellite or base station in a 6G network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including SM and MM procedure conflict handling in accordance with various implementations of the present disclosure.

In some implementations, communication apparatus 410 may also include a transceiver 416 coupled to processor 412 and capable of wirelessly transmitting and receiving data. In some implementations, communication apparatus 410 may further include a memory 414 coupled to processor 412 and capable of being accessed by processor 412 and storing data therein. In some implementations, network apparatus 420 may also include a transceiver 426 coupled to processor 422 and capable of wirelessly transmitting and receiving data. In some implementations, network apparatus 420 may further include a memory 424 coupled to processor 422 and capable of being accessed by processor 422 and storing data therein. Accordingly, communication apparatus 410 and network apparatus 420 may wirelessly communicate with each other via transceiver 416 and transceiver 426, respectively.

To aid better understanding, the following description of the operations, functionalities and capabilities of each of communication apparatus 410 and network apparatus 420 is provided in the context of a mobile communication environment in which communication apparatus 410 is implemented in or as a communication apparatus or a UE and network apparatus 420 is implemented in or as a network node of a communication network.

### Illustrative Processes

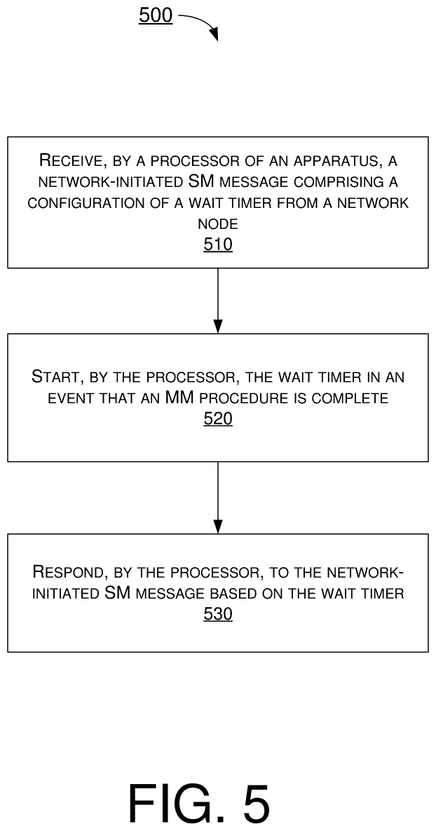

FIG. 5 illustrates an example process 500 in accordance with an implementation of the present disclosure. Process 500 may be an example implementation of above scenarios/schemes, whether partially or completely, with respect to SM and MM procedure conflict handling of the present disclosure. Process 500 may represent an aspect of implementation of features of communication apparatus 410. Process 500 may include one or more operations, actions, or functions as illustrated by one or more of blocks 510 to 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by communication apparatus 410 or any suitable UE or machine type devices. Solely for illustrative purposes and without limitation, process 500 is described below in the context of communication apparatus 410. Process 500 may begin at block 510.

At block 510, process 500 may involve processor 412 of communication apparatus 410 receiving, via transceiver 416, a network-initiated SM message comprising a configuration of a wait timer from a network node (e.g., network apparatus 420). Process 500 may proceed from block 510 to block 520.

At block 520, process 500 may involve processor 412 of communication apparatus 410 starting the wait timer in an event that an MM procedure is complete. Process 500 may proceed from block 520 to block 530.

At block 530, process 500 may involve processor 412 of communication apparatus 410 responding to the network-initiated SM message based on the wait timer.

In some implementations, process 500 may further involve processor 412 of communication apparatus 410 determining whether a re-transmission network-initiated SM message transmitted by the network node is received before the wait timer expires.

In some implementations, process 500 may further involve processor 412 of communication apparatus 410 determining a response message for the re-transmission network-initiated SM message in an event that the re-transmission network-initiated SM message is received before the wait timer expires. Also, process 500 may involve processor 412 of communication apparatus 410 transmitting, via transceiver 416, the response message for the re-transmission network-initiated SM message to the network node.

In some implementations, process 500 may further involve processor 412 of communication apparatus 410 deferring a processing of the network-initiated SM message. Furthermore, process 500 may involve processor 412 of communication apparatus 410 discarding the deferred network-initiated SM message.

In some implementations, process 500 may further involve processor 412 of communication apparatus 410 deferring a processing of the network-initiated SM message. Process 500 may also involve processor 412 of communication apparatus 410 determining a response message for the deferred network-initiated SM message in an event that the re-transmission network-initiated SM message is not received before the wait timer expires. Furthermore, process 500 may involve processor 412 of communication apparatus 410 transmitting, via transceiver 416, the response message for the deferred network-initiated SM message to the network node.

In some implementations, if the re-transmission network-initiated SM message is received after the wait timer expires, process 500 may further involve processor 412 of communication apparatus 410 discarding the re-transmission network-initiated SM message.

In some implementations, process 500 may involve processor 412 of communication apparatus 410 detecting the MM procedure after sending an MM location registration message. Specifically, the MM procedure conflicts with an SM procedure associated with the network-initiated SM message, and the wait timer is started in an event that the MM procedure is complete.

In some implementations, if the network-initiated SM message does not comprise the configuration of the wait timer, process 500 may further involve processor 412 of communication apparatus 410 deferring a processing of the network-initiated SM message. Also, process 500 may involve processor 412 of communication apparatus 410 transmitting, via transceiver 416, a response message for the deferred network-initiated SM message in an event that the MM procedure is complete.

In some implementations, a value of the wait timer is specified in a GPRS timer IE.

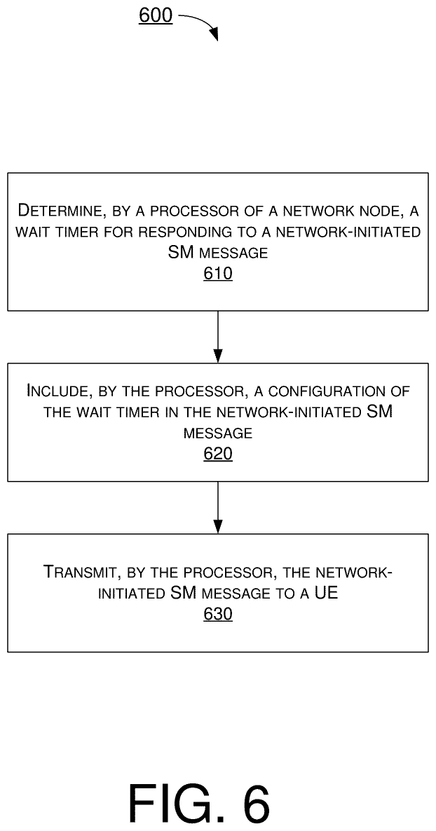

FIG. 6 illustrates an example process 600 in accordance with an implementation of the present disclosure. Process 600 may be an example implementation of above scenarios/schemes, whether partially or completely, with respect to SM and MM procedure conflict handling in mobile communications. Process 600 may represent an aspect of implementation of features of network apparatus 420. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may be implemented by network apparatus 420 or any base stations or network nodes. Solely for illustrative purposes and without limitation, process 600 is described below in the context of network apparatus 420. Process 600 may begin at block 610.

At block 610, process 600 may involve processor 422 of network apparatus 420 determining a wait timer for responding to a network-initiated SM message. Process 600 may proceed from block 610 to block 620.

At block 620, process 600 may involve processor 422 of network apparatus 420 including a configuration of the wait timer in the network-initiated SM message. Process 600 may proceed from block 620 to block 630.

At block 630, process 600 may involve processor 422 of network apparatus 420 transmitting, via transceiver 426, the network-initiated SM message to a UE (e.g., communication apparatus 410).

In some implementations, a value of the wait timer is specified in a GPRS timer IE.

In some implementations, an MM procedure conflicts with an SM procedure associated with the network-initiated SM message.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a network-initiated session management (SM) message comprising a configuration of a wait timer from a network node;
starting, by the processor, the wait timer in an event that a mobility management (MM) procedure is complete; and
responding, by the processor, to the network-initiated SM message based on the wait timer.

2. The method of claim 1, further comprising:
determining, by the processor, whether a re-transmission network-initiated SM message transmitted by the network node is received before the wait timer expires.

3. The method of claim 2, wherein the responding to the network-initiated SM message based on the wait timer further comprises:
determining a response message for the re-transmission network-initiated SM message in an event that the re-transmission network-initiated SM message is received before the wait timer expires; and
transmitting the response message for the re-transmission network-initiated SM message to the network node.

4. The method of claim 3, further comprising:
deferring, by the processor, a processing of the network-initiated SM message; and
discarding, by the processor, the deferred network-initiated SM message.

5. The method of claim 2, wherein the responding to the network-initiated SM message based on the wait timer further comprises:
deferring, by the processor, a processing of the network-initiated SM message;
determining a response message for the deferred network-initiated SM message in an event that the re-transmission network-initiated SM message is not received before the wait timer expires; and
transmitting the response message for the deferred network-initiated SM message to the network node.

6. The method of claim 5, wherein in an event that the re-transmission network-initiated SM message is received after the wait timer expires, the method further comprises:
discarding, by the processor, the re-transmission network-initiated SM message.

7. The method of claim 1, further comprising:
detecting, by the processor, the MM procedure after sending an MM location registration message,
wherein the MM procedure conflicts with an SM procedure associated with the network-initiated SM message, and the wait timer is started in an event that the MM procedure is complete.

8. The method of claim 1, wherein in an event that the network-initiated SM message does not comprise the configuration of the wait timer, the method further comprises:
deferring, by the processor, a processing of the network-initiated SM message; and
transmitting, by the processor, a response message for the deferred network-initiated SM message in an event that the MM procedure is complete.

9. The method of claim 1, wherein a value of the wait timer is specified in a general packet radio service (GPRS) timer information element (IE).

10. An apparatus, comprising:
a transceiver which, during operation, communicates wirelessly; and
a processor communicatively coupled to the transceiver such that, during operation, the processor performs operations comprising:
receiving, via the transceiver, a network-initiated session management (SM) message comprising a configuration of a wait timer from a network node;
starting the wait timer in an event that a mobility management (MM) procedure is complete; and
responding to the network-initiated SM message based on the wait timer.

11. The apparatus of claim 10, wherein during operation, the processor further performs operations comprising:
determining whether a re-transmission network-initiated SM message transmitted by the network node is received before the wait timer expires.

12. The apparatus of claim 11, wherein during operation, the processor further performs operations comprising:
determining a response message for the re-transmission network-initiated SM message in an event that the re-transmission network-initiated SM message is received before the wait timer expires; and
transmitting, via the transceiver, the response message for the re-transmission network-initiated SM message to the network node.

13. The apparatus of claim 12, wherein during operation, the processor further performs operations comprising:
deferring a processing of the network-initiated SM message; and
discarding the deferred network-initiated SM message.

14. The apparatus of claim 11, wherein during operation, the processor further performs operations comprising:
deferring a processing of the network-initiated SM message;
determining a response message for the deferred network-initiated SM message in an event that the re-transmission network-initiated SM message is not received before the wait timer expires; and
transmitting, via the transceiver, the response message for the deferred network-initiated SM message to the network node.

15. The apparatus of claim 14, wherein in an event that the re-transmission network-initiated SM message is received after the wait timer expires, and during operation, the processor further performs operations comprising:
discarding the re-transmission network-initiated SM message.

16. The apparatus of claim 10, wherein during operation, the processor further performs operations comprising:
detecting the MM procedure after sending an MM location registration message,
wherein the MM procedure conflicts with an SM procedure associated with the network-initiated SM message, and the wait timer is started in an event that the MM procedure is complete.

17. The apparatus of claim 10, wherein in an event that the network-initiated SM message does not comprise the configuration of the wait timer, and during operation, the processor further performs operations comprising:
deferring a processing of the network-initiated SM message; and
transmitting, via the transceiver, a response message for the deferred network-initiated SM message in an event that the MM procedure is complete.

18. The apparatus of claim 10, wherein a value of the wait timer is specified in a general packet radio service (GPRS) timer information element (IE).

19. A method, comprising:
determining, by a processor of a network node, a wait timer for responding to a network-initiated session management (SM) message;
including, by the processor, a configuration of the wait timer in the network-initiated SM message; and
transmitting, by the processor, the network-initiated SM message to a user equipment (UE).

20. The method of claim 19, wherein:
a value of the wait timer is specified in a general packet radio service (GPRS) timer information element (IE); and
a mobility management (MM) procedure conflicts with an SM procedure associated with the network-initiated SM message.
